(19) United States
(12) Patent Application Publication
(10) Pub. No.: US 2021/0331181 A1
(43) Pub. Date: Oct. 28, 2021

(54) Compositions and Methods for Controlling pH in Metal Flotation Processes

(71) Applicant: Lixivia, Inc., Santa Babara, CA (US)

(72) Inventor: Michael D. Wyrsta, Santa Barbara, CA (US)

(21) Appl. No.: 17/264,579

(22) PCT Filed: Jul. 26, 2019
(86) PCT No.: PCT/US19/43679

§ 371 Date: Jan. 29, 2021

Related U.S. Application Data
(60) Provisional application No. 62/712,119, filed on Jul. 30, 2018.

(51) Int. Cl. B03D 1/001; B03D 1/002; B03D 1/008; B03D 1/01

(52) U.S. Cl. CPC B03D 1/001; B03D 1/002; B03D 2203/02; B03D 1/01; B03D 2201/007; B03D 1/008

(57) ABSTRACT

Compositions for adjusting the pH of sea water to be useful in metal floatation processes are described, as are methods utilizing such compositions. Precipitation of insoluble magnesium salts interferes with pH adjustment of sea water when conventional sources of CaO and/or Ca(OH)₂ are used, however addition of nonreactive particulates (such as waste materials from industrial processes) permits use of such low quality sources of CaO/Ca(OH)₂ and reduces consumption of high quality CaO/Ca(OH)₂ for this purpose.

This application claims the benefit of U.S. Provisional Application No. 62/712,119 filed on Jul. 30, 2018. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is separation of metal-enriched fractions from ore by flotation, particularly using sea water.

### BACKGROUND

The following description includes information that may be useful in understanding the present invention. It is not an admission that any of the information provided herein is prior art or relevant to the presently claimed invention, or that any publication specifically or implicitly referenced is prior art.

Flotation processes are often used in the recovery of commercially valuable metals from relatively low-grade ores (such as secondary ore bodies or low-grade primary ore bodies). Such floatation processes utilize differences in hydrophobicity to associate mineral-bearing particulates with air bubbles introduced by sparging air into an aqueous suspension of particulate ore. Surfactants and other compounds are often added to enhance this effect. The resulting metal-enriched foam collects at the top of the suspension, where it is readily collected. The depleted solution is often subjected to additional floatation processing in order to recover additional metal, and in some instances the metal-enriched foam so collected is returned to the primary flotation step to permit metal recovery. Following such extractions, the remaining particulates, which have low metal content, are discarded or utilized for other purposes. This set of processes is referred to as a flotation circuit.

Such aqueous flotation circuits generally need to maintain a pH of greater than 11 in order to effectively float metallic elements. The material of choice to raise pH in these circuits is a source of calcium hydroxide or calcium oxide (e.g. lime). Historically, the water sources utilized have been fresh water sources. Fresh water, however, is consistently in high demand and is quickly becoming a scarce resource. This has forced many mining operations to adapt their processes to utilize sea water, which contains abundant salts and pH buffering species that can make recovery of certain metals difficult. In practice, however, it is difficult to raise the pH of sea water above 10.5 using conventional industrial quality lime/hydrated lime. Various solutions, including desalination or partial desalination of sea water have been proposed (Cisternas and Galvez, Mineral processing and Extractive Metallurgy Review, October 2017). The energy requirements for desalination, however, can have a significant negative environmental impact. While partial desalination requires less energy it has yet to be effectively implemented. All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In addition to the presence of buffering species in sea water that resist increasing pH, the magnesium chloride present in sea water can act to effectively block lime dissolution. Calcium hydroxide (Ca(OH)₂) has a limited solubility in water. When calcium hydroxide is introduced into a solution containing magnesium chloride (such as sea water), insoluble magnesium hydroxide is produced. This reaction happens rapidly at the interface of sea water and calcium hydroxide-containing lime particles, effectively forming a shell of insoluble Mg(OH)₂ around the surface of the lime particle. Such an encapsulated lime particle no longer contributes effectively to the pH modification of the flotation water.

Thus, there is still a need for compositions and methods that permit the use of sea water in metal floatation methods.

### SUMMARY OF THE INVENTION

The inventive subject matter provides apparatus, systems and methods in which either purified CaO/Ca(OH)₂ or non-reactive particles in combination with purified CaO/Ca(OH)₂ and/or low quality lime are mixed with sea water to raise the pH to above or about 10.5, 11, or higher in order to support float circuits used in ore processing. While low quality lime has proven to be ineffective at raising sea water pH, the Inventors have surprisingly found that use of either purified CaO/Ca(OH)₂ or non-reactive particles in combination with purified CaO/Ca(OH)₂ and/or low quality lime can do so effectively and economically. Additional embodiments include related compositions and flotation circuits.

Embodiments of the inventive concept include a composition for use in adjusting the pH of sea water to an alkaline range (e.g. above or about pH 10.5, pH 11 or higher) which includes a plurality of first particulates (for example, particulates with a mean diameter of from about 5 μm to about 500 μm) that include a basic compound and a plurality of second particulates that are non-reactive with sea water, where the plurality of second particulates is present in at least a 1:1, 10:1, or 100:1 w/w ratio relative to the first particulates. Suitable basic compounds include Group I metal oxides and/or hydroxides, nitrogen-based basic compounds or organic amines, and Group II metal oxides and/or hydroxides (such as lime or composition that includes CaO or Ca(OH)₂ at a purity of 70% to 95%, or higher).

Another embodiment of the inventive concept is a method of adjusting pH of sea water to above or about pH 10.5, pH 11 or higher, by contacting seawater with 95% CaO, Ca(OH)₂, or a mixture thereof in the absence of additional pH adjusting agents to generate a pH adjusted sea water with pH of about 10.5, 11, or higher, where the 95% CaO, Ca(OH)₂, or the mixture thereof is provided at 0.5 kg or more per metric ton of sea water.

Another embodiment of the inventive concept is a method of adjusting pH of sea water to above or about pH 10.5, 11, or higher, by contacting sea water, in the absence of additional pH adjusting agents, with a plurality of first particulates that include a basic compound and a plurality of second particulates that are non-reactive with sea water at an at least a 1:1, 10:1, or 100:1 w/w ratio with the first particulates in order to generate a pH adjusted sea water with pH of about 10.5, 11, or higher. In some of such embodiments sea water is contacted with the first and second particulates essentially simultaneously. In other embodiments the sea water is contacted with the second particulates prior to application of the first particulates. Suitable basic compounds include Group I metal oxides and/or hydroxides, nitrogen-based basic compounds or organic amines, and Group II metal oxides and/or hydroxides (for example, lime or a composition that includes CaO, Ca(OH)₂, or a combination thereof at a purity of at least 70% to 95% or higher).

Another embodiment of the inventive concept is a flotation circuit for concentrating metal-rich particulates from an ore that includes a conditioner (810) with an upper portion and a lower portion, and that is in fluid communication with a source of sea water. The flotation circuit also includes a primary foam fractioner (820) that has an upper portion and a lower portion and that is in fluid communication with the lower portion of the conditioner (810). A first collection conduit for a primary concentrate derived from the ore can be in fluid communication with the upper portion of the primary foam fractioner (820). Such a flotation circuit also includes a source of first particulates that include a base, where the source of first particulates is in fluid communication with at least one of the conditioner (810) and the primary foam fractioner (820). In some embodiments the flotation circuit includes a source of ore that is in fluid communication with the conditioner (810), and can include a re-sizing device positioned between the source of ore and the conditioner (810). In some embodiments the flotation circuit can include a source of second particulates that are non-reactive with sea water, where the source of second particulates is in fluid communication with at least one of the conditioner (810) and the primary foam fractioner (820).

In some embodiments of the flotation circuit the lower portion of the primary foam fractioner (820) is in fluid communication with a secondary foam fractioner (830), which has an upper portion and a lower portion. In such embodiments the upper portion of the secondary foam fractioner (830) can be in fluid communication with the conditioner (810). A second collection conduit that is in fluid communication with the lower portion of the secondary foam fractioner (830) can be used to collect tailings derived from ore.

Another embodiment of the inventive concept is a method for recovering a metal from an ore, by contacting the ore with an extraction mixture that includes sea water and a plurality of first particles that include a basic compound to form an ore suspension, where pH of the extraction mixture is at least 10.5, 11, or higher. Suitable basic compounds include Group I metal oxides and/or hydroxides, nitrogen-based basic compounds or organic amines, and Group II metal oxides and/or hydroxides (for example, lime or a composition that includes CaO, Ca(OH)₂, or a combination thereof at a purity of at least 70% to 95% or higher). The ore suspension is then sparged with a gas (such as air) to form a plurality of gas bubbles within the ore suspension for a time that is sufficient to form a first foam. This first foam includes a primary concentrate enriched in the metal, and is collected. In some embodiments the ore is also contacted with a plurality of second particles that are non-reactive with sea water. In such embodiments the second particles can introduced to the ore prior to contacting with the extraction mixture. Alternatively, the second particles can introduced to the ore during contacting with the extraction mixture. In other embodiments the second particles are added to the extraction mixture prior to contacting the ore. Such second particulates can be used present at an at least a 1:1, 10:1, 100:1, or higher w/w ratio relative to the first particulates.

Some embodiments of such a method further include a step of collecting an extracted ore after sparging, and further sparging the extracted ore with the gas to generate a secondary concentrate and tailings. In such embodiments he secondary concentrate can be returned to a previous step to bring it in contact with the extraction mixture. Tailings can be further processed to extract or enrich an additional metal.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1: Typical results of attempts to adjust the pH of sea water using low quality lime.

FIG. 2: Typical results of the use of high purity CaO/Ca(OH)₂ particles (i.e. SELEX lime) and low quality lime (i.e. 70% lime) to modify the pH of sea water. The pH of sea water is raised above 10.5 with as little as 1 kg high purity CaO/Ca(OH)₂ particles per metric ton of sea water, and reaches 11 at 3 kg per metric ton.

FIG. 3: Typical results of the use of non-reactive particulates (i.e. Alkanex) in combination with low quality lime (black line) and low quality lime alone (i.e. 70% lime, open line) in adjusting the pH of sea water. As shown by low quality lime in the absence of non-reactive particulates is ineffective in raising the pH of sea water above 10.5. When used in concert with non-reactive particulates, however, low quality lime can raise the pH of sea water above 10.5 with the use of as little as 2 kg of lime per metric ton of sea water and can achieve a pH of 11 at about 4 kg per metric ton of sea water.

FIG. 4: Typical results of the use of high purity CaO/Ca(OH)₂ particulates (i.e. SELEX) in combination with non-reactive particulates (i.e. Alkanex, dotted line) in adjusting the pH of sea water. As shown, low quality lime alone (open line) is ineffective in adjusting the pH of sea water to 10.5 or above. The use of non-reactive particulates in combination with high purity CaO/Ca(OH)₂ particulates (dotted line) provides a pronounced increase in sea water pH at relatively low concentrations of calcium-containing particulates, providing a pH increase to at least 10.5 with as little as 0.5 kg high purity CaO/Ca(OH)₂ particulates per metric ton of sea water. The use of non-reactive particulates also permits adjustment of sea water pH to 10.5 or higher when used in combination with low quality lime (black line).

FIGS. 5A to 5C: FIGS. 5A to 5C schematically depict methods of the inventive concept utilizing high purity CaO/Ca(OH)₂ without the use of non-reactive particulates. FIG. 5A depicts an embodiment in which high purity CaO/Ca(OH)₂ is added to a conditioner that receives ore and seawater. FIG. 5B depicts an embodiment in which high purity CaO/Ca(OH)₂ is added to a foam fractioner that is downstream from the conditioner. FIG. 5C depicts an embodiment in which high purity CaO/Ca(OH)₂ is added to both a conditioner that receives ore and seawater and a foam fractioner that is downstream from the conditioner.

FIGS. 6A to 6D: FIGS. 6A to 6D schematically depict methods of the inventive concept utilizing high purity CaO/Ca(OH)₂ in combination with non-reactive particulates. FIG. 6A depicts an embodiment in which high purity CaO/Ca(OH)₂ and non-reactive particulates are added to a conditioner that receives ore and seawater. FIG. 6B depicts an embodiment in which non-reactive particulates are added to the conditioner and high purity CaO/Ca(OH)₂ is added to a foam fractioner that is downstream from the conditioner. FIG. 6C depicts an embodiment in which both non-reactive particulates and high purity CaO/Ca(OH)₂ are added to a foam fractioner that is downstream from the conditioner. FIG. 6D depicts an embodiment in which both non-reactive particulates and high purity CaO/Ca(OH)₂ are added to both a conditioner that receives ore and seawater and a foam fractioner that is downstream from the conditioner.

FIGS. 7A to 7D: FIGS. 7A to 7D schematically depict methods of the inventive concept utilizing low quality lime in combination with non-reactive particulates. FIG. 7A depicts an embodiment in which low quality lime and non-reactive particulates are added to a conditioner that receives ore and seawater. FIG. 7B depicts an embodiment in which non-reactive particulates are added to the conditioner and low quality lime is added to a foam fractioner that is downstream from the conditioner. FIG. 7C depicts an embodiment in which both non-reactive particulates and low quality lime are added to a foam fractioner that is downstream from the conditioner. FIG. 7D depicts an embodiment in which both non-reactive particulates and low quality lime are added to both a conditioner that receives ore and seawater and a foam fractioner that is downstream from the conditioner.

FIG. 8: A schematic depiction of an exemplary flotation circuit of the inventive concept for recovery of metals from ores.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems and methods in which a base, for example a Group I metal oxide or hydroxide (for example, NaOH, KOH, etc.), a Group II metal oxide or hydroxide (for example from 70% to 95% or higher purity CaO and/or Ca(OH)₂), and/or one or more organic or nitrogen-based basic compounds (such as ammonium hydroxide and/or an organic amine) along with a plurality of nonreactive particulates (such as steel slag, ash, sand, etc.) are applied to sea water in order to produce a pH in excess of 10.5 (e.g. a pH of 11 or higher) that is suitable for metal floatation processes. In some embodiments a highly purified calcium oxide or hydroxide preparation (i.e. 95% or higher purity) can be applied to sea water in the absence of additional nonreactive particulates in order to produce a pH in excess of 10.5 (e.g. a pH of 11 or higher) that is suitable for metal floatation processes.

Various objects, features, aspects and advantages of the inventive subject matter will become more apparent from the following detailed description of preferred embodiments, along with the accompanying drawing figures in which like numerals represent like components.

One should appreciate that the disclosed techniques provide many advantageous technical effects including permitting the use of abundantly available sea water in metal flotation processes. This not only reduces expense associated with such processes, it also serves to reduce utilization of increasingly scarce fresh water resources. One should also appreciate that it is unexpected, based on experience with conventional lime products and magnesium salt precipitation, to find that use of high purity lime alone can achieve pH greater than 10.5 in sea water and that use of low purity lime in combination with a “spectator” (i.e. nonreactive) solid can also achieve a pH above 10.5 or higher in sea water.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

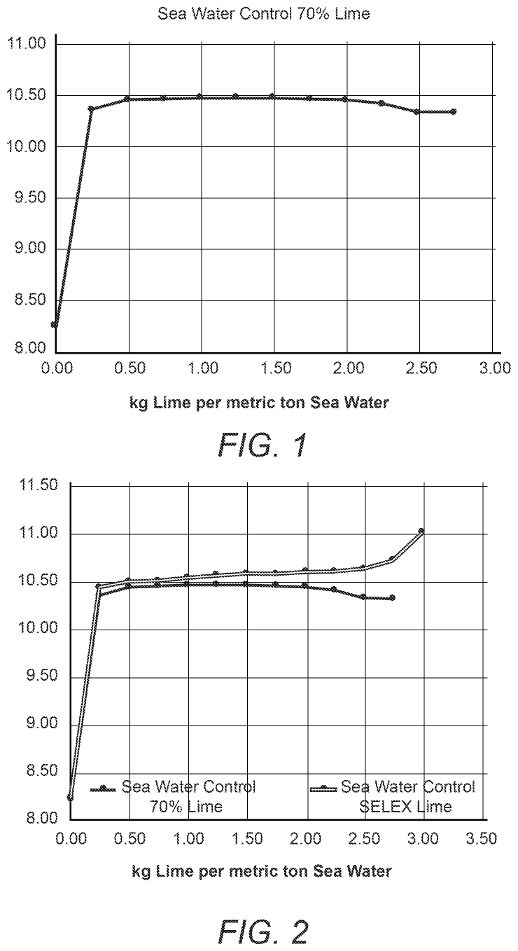

While it is known that low quality lime can provide a source of calcium oxide and/or calcium hydroxide that is adequate for many applications, Inventors have found that it is ineffective in raising the pH of sea water adequately for metal flotation (e.g. to a pH of greater than 10.5). Typical results for the effect of the addition of low quality lime on the pH of sea water are shown in FIG. 1. While widely available low quality lime typically contains about 70% CaO/Ca(OH)₂) it is ineffective in raising the pH of sea water above 10.5, even when applied at relatively high concentrations. Without wishing to be bound by theory the Inventors believe that this may be due to lack of accessible CaO and/or Ca(OH)₂ on particles of such material, compounded by precipitation of insoluble magnesium salts on the particle's surface (encapsulation) on exposure to sea water.

Inventors have surprisingly found that high purity CaO and/or Ca(OH)₂ (such as SELEX) can be used in relatively small quantities to adjust the pH of sea water into a range that is adequate for metal flotation processes (e.g. in excess of pH 10.5). In one embodiment of the inventive concept, relatively high purity CaO and/or Ca(OH)₂ particles are utilized to effect modification of seawater pH to greater than 10.5 (e.g. a pH of 11) in a floatation circuit utilized for isolation of metals. Such CaO/Ca(OH)₂ particles can have an average diameter of at least 5 μm (for example, an average particle diameter of from about 5 μm to about 500 μm, or from about 10 μm to about 200 μm), and can have a purity of 95% or higher.

Without wishing to be bound by theory, the Inventors believe that such high purity CaO/Ca(OH)₂ particles may provide sufficient CaO/Ca(OH)₂ content to generate sufficient alkaline buffering capacity to adjust the pH of seawater to greater than 10.5 for such flotation operations, despite being coated by insoluble Mg(OH)₂ in the process. Alternatively, such CaO/Ca(OH)₂ particles may be sufficiently soluble to avoid encapsulation seen with low quality lime, possibly by dissolution prior to formation of a Mg(OH)₂ layer thick enough to block sea water access to the calcium-containing particle within.

Suitable high purity CaO/Ca(OH)₂ particles are obtainable by extraction of low quality calcium sources (such as industrial waste, steel slag, fly ash, etc.) with organic amine lixiviants followed by precipitation of high purity CaCO₃ particles using a source of CO₂, with subsequent conversion of CaCO₃ to CaO/Ca(OH)₂ via calcination.

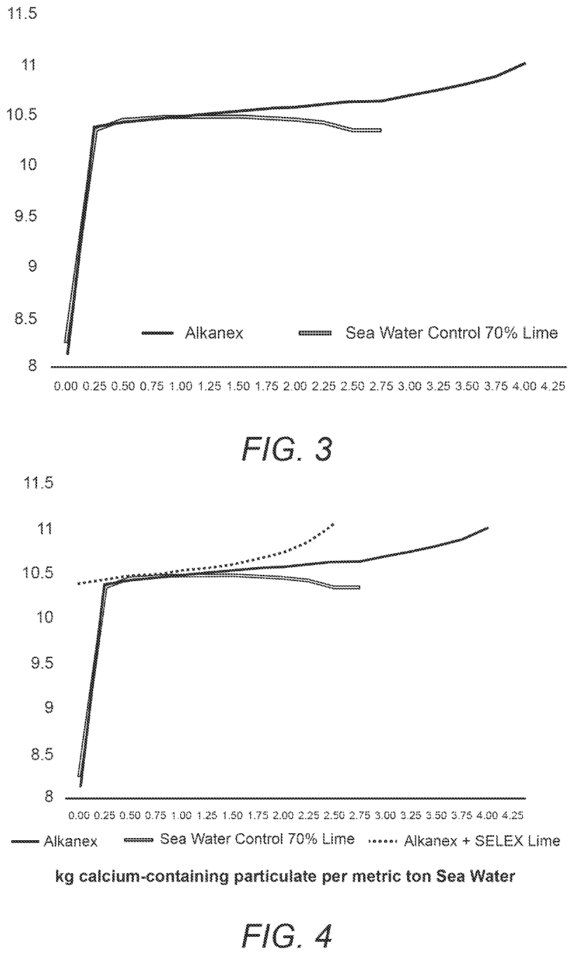

The amount of high purity CaO/(OH)₂ particles utilized can be optimized for the flotation process in which sea water is to be used, ore composition, and local sea water composition (which can be impacted by fresh water runoff, industrial pollution, etc.). For example, a high purity CaO/Ca(OH)₂ particle composition produced as described above can be applied to effectively raise the pH of sea water in amounts of about 1 kg or more per metric ton of sea water, as shown in FIG. 2. As shown, whereas low quality lime (designated 70% lime) does not raise the pH of sea water effectively to pH 10.5 or higher regardless of the amount used a high purity CaO/Ca(OH)₂ preparation (designated SELEX) is effective at doing so at concentrations as low about 1 kg per metric ton of sea water. In addition, use of additional high purity CaO/Ca(OH)₂ increases pH of treated sea water even further.

In another embodiment of the inventive concept, the Inventors have surprisingly found that the introduction of non-reactive (i.e. “spectator”) particulates to sea water can improve the performance of calcium-containing particulates (such as low quality lime or high purity CaO/Ca(OH)₂) in raising sea water pH. Such non-reactive particulates can be added prior to or concurrent with the addition of calcium-containing particulates. Such non-reactive particulates can be provided at a 1:1, 2:1, 3:1, 4:1, 5:1, 10:1, 20:1, 50:1, 100:1, or higher w/w ratio relative to the amount of lime or high purity CaO/Ca(OH)₂ utilized. Without wishing to be bound by theory, the Inventor believes that such non-reactive particulates may act as alternative nucleation centers for the precipitation of insoluble Mg(OH)₂ from sea water that occurs on the addition of CaO and/or Ca(OH)₂, thereby reducing the amount of insoluble Mg(OH)₂ available for coating the surface of particulates containing such calcium salts.

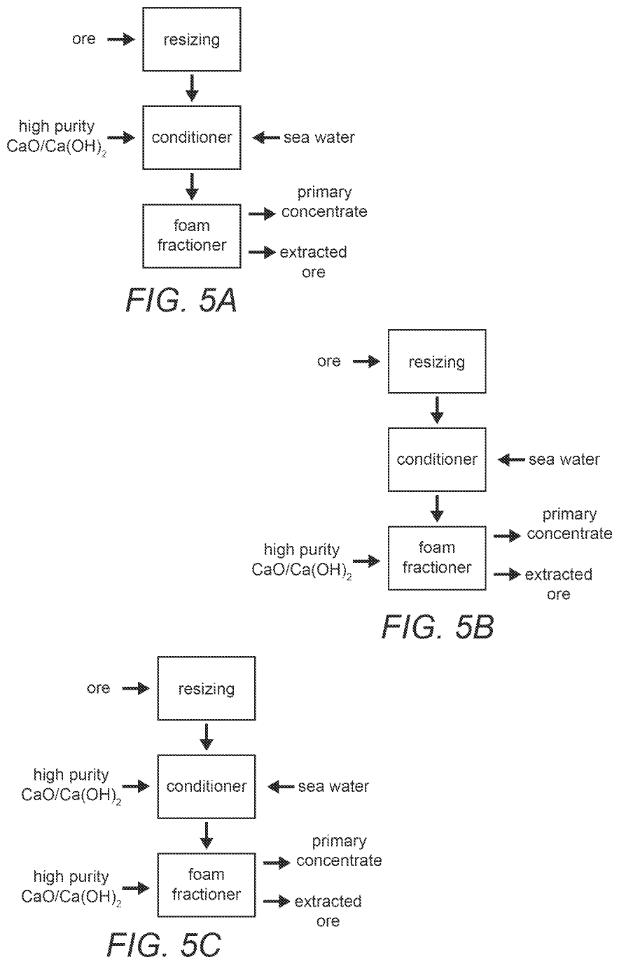

Since little or no surface chemistry occurs, a broad variety of materials are suitable for use as such non-reactive particulates. Suitable materials include industrial wastes, such as aluminum slag, copper slag, iron and/or steel slags, fly ash, copper tailings, diatomite, sand, ash derived from biomass, etc. For example, the steel slag product Alkanex has been found to be suitable for this purpose. Results from the use of such non-reactive particulates with low quality lime in adjusting the pH of sea water are shown in FIG. 3. As shown conventional low-quality lime alone (designated 70% lime, represented by the open line) fails to increase the pH of sea water above about 10.5, regardless of the amount used. When used in combination with non-reactive particulates (i.e. Alkanex), however, low-quality lime was able to increase the pH of sea water to above 10.5 when applied at as little as about 1.5 to 2 kg per metric ton of sea water and achieved a pH of about 11 when added at about 4 kg per metric ton of sea water (black line).

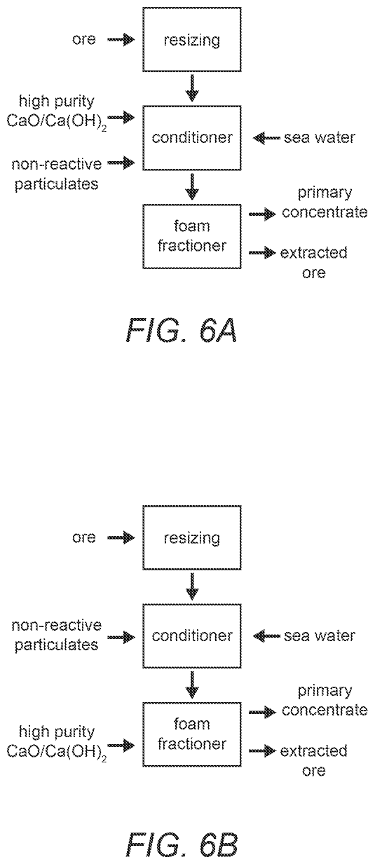

In another embodiment of the inventive concept, high purity CaO/Ca(OH)₂ particulates (such as SELEX) can be used in combination with non-reactive particulates (such as Alkanex) to adjust the pH of sea water to 10.5 or above. As noted above, such non-reactive particulates can be added to the sea water prior to or concurrent with the addition of high purity CaO/(OH)₂ particulates. Results of such a combination are shown in FIG. 4, which shows results when used with SELEX as a source of high purity CaO/Ca(OH)₂. As shown, low-quality lime (i.e. 70% lime) alone is ineffective at raising the pH of sea water above about 10.5 (open line). Such low quality lime, however, can be used effectively in combination with a non-reactive particulate (such as Alkanex) to increase the pH of sea water to above 10.5 when applied at about 3 kg per metric ton of sea water and was able to increase the pH to about 11 when applied at about 4 or more kg per metric ton of sea water (black line).

FIG. 4 also shows the effects of combining the use of non-reactive particulates (such as Alkanex) with high purity CaO/(OH)₂ (such as SELEX). As shown, when used in combination with non-reactive particulates, high purity CaO/(OH)₂ can raise the pH of sea water to above about 10.5 when applied at 0.5 kg per metric ton of sea water, and raises the pH of sea water to about 11 when applied at about 2 to 2.25 kg per metric ton of sea water (dotted line).

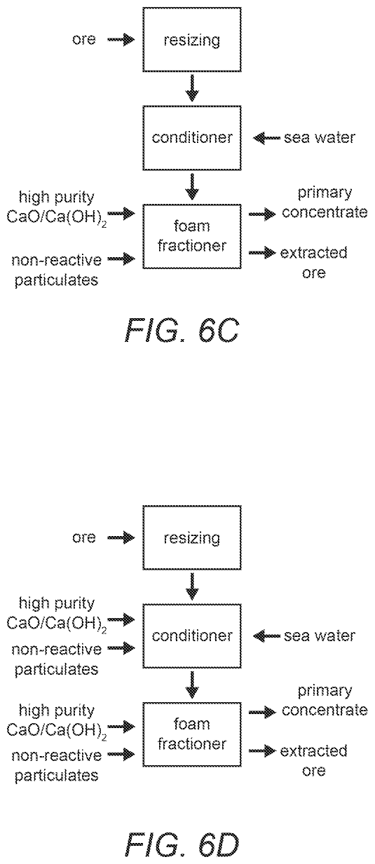

In some embodiments of the inventive concept a primary concentrate that is enriched in a metal of interest can be recovered from an ore using sea water-based flotation techniques in combination with the application of high purity CaO/Ca(OH)₂ or, alternatively, the application of high purity Ca)/Ca(OH)₂ or low quality lime in concert with particulates that are non-reactive with sea water. Examples of such methods are shown schematically in FIGS. 5A to 5C.

As shown in FIG. 5A, in an exemplary embodiment of the inventive concept an ore that includes the metal of interest can, if necessary, first be resized (for example, by grinding, milling, sieving, etc.) to provide a pulp that includes ore particles of a suitable size (e.g. having an average diameter of from about 50 μm to 5 mm, inclusive of intermediate values). This ore pulp can be transferred to a conditioner, where it is contacted with sea water. In some embodiments such sea water is used as collected from a natural source. In other embodiments the sea water can be partially desalinated. The ore pulp is also contacted with high purity 95%) CaO/Ca(OH)₂ in quantities sufficient to adjust the pH to a desired range (e.g. equal to or greater than pH 10.5, equal to or greater than pH 11, etc.). For example, CaO/Ca(OH)₂ can be applied at about 1.5 kg per metric ton of sea water. In such embodiments the high purity CaO/Ca(OH)₂ can be added to the conditioner (as shown in FIG. 5A). The mixture is then transferred to a foam fractioner where gas bubbles are introduced. A primary concentrate that is enriched in the metal of interest is collected from the upper portion of the foam fractioner, and extracted ore is collected from the lower portion of the foam fractioner. In some embodiments the extracted ore can be further processed (for example, in one or more additional rounds of foam fractioning), with low density materials collected from such additional steps and returned to the conditioner to form a partially closed circuit.

It should be appreciated that, while high purity CaO/Ca(OH)₂ is shown in FIG. 5A as being added to the conditioner, in some embodiments the high purity CaO/Ca(OH)₂ can be added to the foam fractioner (FIG. 5B) or to both the conditioner and the foam fractioner (FIG. 5C). Alternatively, high purity CaO/Ca(OH)₂ can be mixed with sea water prior to mixing with the ore.

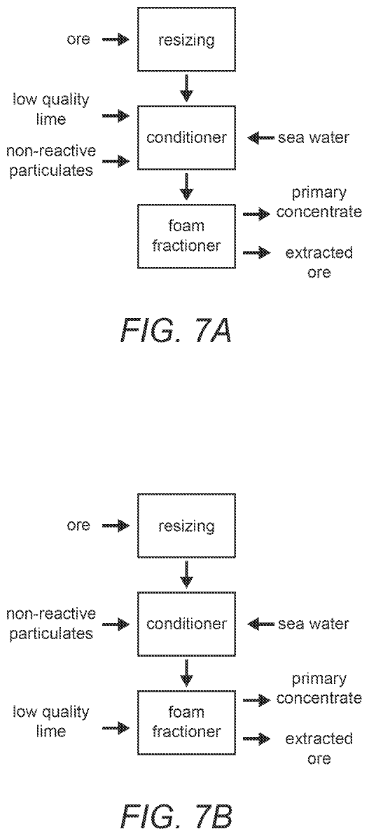

As noted above, Inventors have found that the addition of particulates that are non-reactive with sea water unexpectedly reduces the amount of high purity CaO/Ca(OH)₂ needed to adjust the pH of sea water. As shown in FIG. 6A, in an exemplary embodiment of the inventive concept an ore that includes the metal of interest can, if necessary, first be resized (for example, by grinding, milling, sieving, etc.) to provide a pulp that includes ore particles of a suitable size (e.g. having an average diameter of from about 50 μm to 5 mm, inclusive of intermediate values). This ore pulp can be transferred to a conditioner, where it is contacted with sea water. In some embodiments such sea water is used as collected from a natural source. In other embodiments the sea water can be partially desalinated. The ore pulp is also contacted with high purity 95%) CaO/Ca(OH)₂ and with non-reactive particulates in quantities sufficient to adjust the pH to a desired range (e.g. equal to or greater than pH 10.5, equal to or greater than pH 11, etc.). For example, CaO/Ca(OH)₂ can be applied at about 0.5 kg per metric ton of sea water, and non-reactive particulates can be added at a 1:1 to 100:1 weight ratio to the highly purified CaO/Ca(OH)₂. In such embodiments the high purity CaO/Ca(OH)₂ and the non-reactive particulates can be added to the conditioner (as shown in FIG. 6A). The mixture is then transferred to a foam fractioner where gas bubbles are introduced. A primary concentrate that is enriched in the metal of interest is collected from the upper portion of the foam fractioner, and extracted ore is collected from the lower portion of the foam fractioner. In some embodiments the extracted ore can be further processed (for example, in one or more additional rounds of foam fractioning), with low density materials collected from such additional steps and returned to the conditioner to form a partially closed circuit.

It should be appreciated that, while high purity CaO/Ca(OH)₂ and non-reactive particulates are shown in FIG. 6A as being added to the conditioner, in some embodiments the non-reactive particulates can be added to the conditioner and the high purity CaO/Ca(OH)₂ can be added to the foam fractioner (FIG. 6B). Alternatively, both the non-reactive particulates and the high purity CaO/Ca(OH)₂ can be added to the foam fractioner (FIG. 6C), or to both the conditioner and the foam fractioner (FIG. 6D). Alternatively, high purity CaO/Ca(OH)₂ and non-reactive particulates can be mixed with sea water prior to mixing with the ore. It should be appreciated that in such methods non-reactive particulates should be added essentially simultaneously with or prior to the addition of the high purity CaO/Ca(OH)₂ in order to avoid encapsulation by magnesium salts.

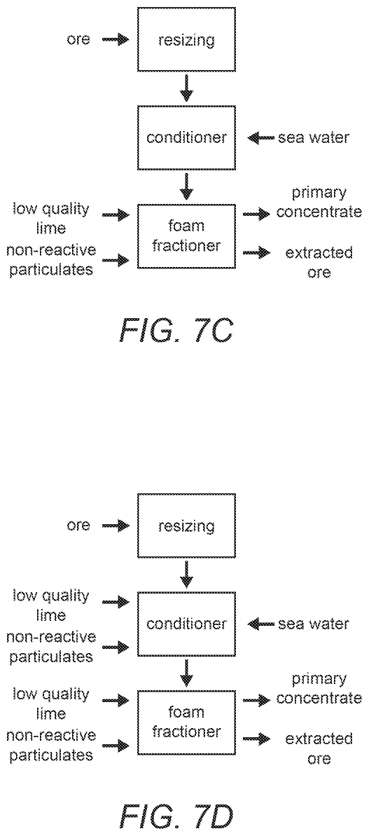

Inventors have, surprisingly, found that the addition of particulates that are non-reactive with sea water advantageously permits the use of low quality lime (e.g. containing about 70% CaO/Ca(OH)₂) to adjust the pH of sea water. As shown in FIG. 7A, in an exemplary embodiment of the inventive concept an ore that includes the metal of interest can, if necessary, first be resized (for example, by grinding, milling, sieving, etc.) to provide a pulp that includes ore particles of a suitable size (e.g. having an average diameter of from about 50 μm to 5 mm, inclusive of intermediate values). This ore pulp can be transferred to a conditioner, where it is contacted with sea water. In some embodiments such sea water is used as collected from a natural source. In other embodiments the sea water can be partially desalinated. The ore pulp is also contacted with low quality lime and with non-reactive particulates in quantities sufficient to adjust the pH to a desired range (e.g. equal to or greater than pH 10.5, equal to or greater than pH 11, etc.). For example, low quality lime can be applied at about 1.5 kg per metric ton of sea water or more, and non-reactive particulates can be added at a 1:1 to 100:1 weight ratio to the low quality lime. In such embodiments the low quality lime and the non-reactive particulates can be added to the conditioner (as shown in FIG. 7A). Alternatively, lime and non-reactive particulates can be mixed with sea water to produce a pH adjusted sea water that is added to the conditioner. The mixture is then transferred to a foam fractioner where gas bubbles are introduced. A primary concentrate that is enriched in the metal of interest is collected from the upper portion of the foam fractioner, and extracted ore is collected from the lower portion of the foam fractioner. In some embodiments the extracted ore can be further processed (for example, in one or more additional rounds of foam fractioning), with low density materials collected from such additional steps and returned to the conditioner to form a partially closed circuit.

It should be appreciated that, while low quality lime and non-reactive particulates are shown in FIG. 7A as being added to the conditioner, in some embodiments the non-reactive particulates can be added to the conditioner and the low quality lime can be added to the foam fractioner (FIG. 7B). Alternatively, both the non-reactive particulates and the low quality lime can be added to the foam fractioner (FIG. 7C), or to both the conditioner and the foam fractioner (FIG. 7D). Alternatively, low quality lime and non-reactive particulates can be mixed with sea water prior to mixing with the ore. It should be appreciated that in such methods non-reactive particulates should be added essentially simultaneously with or prior to the addition of the low quality lime in order to avoid encapsulation by magnesium salts.

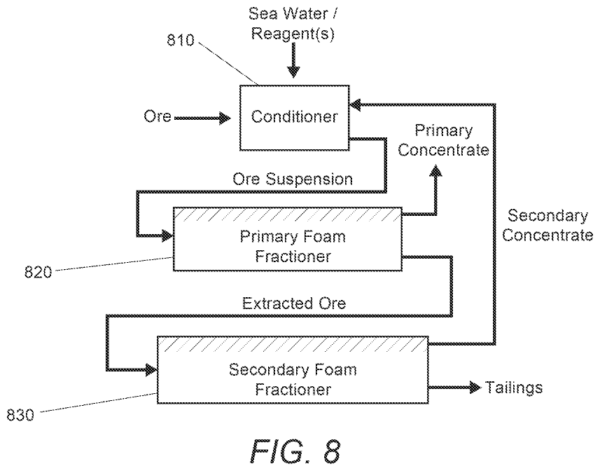

As noted above, floatation processes for recovery of metals from ores are generally performed using a floatation circuit. The materials described above are readily adaptable to such flotation processes and the floatation circuits that perform the concentration of desired metals. An exemplary flotation circuit of the inventive concept is shown in FIG. 8. In such an embodiment ore is initially mixed with sea water or brackish water in a conditioner (810) to form an ore suspension. In some embodiments the ore is fractured, ground, or otherwise re-sized to generate ore particles that are suitable for foam floatation. For example, such ore particles can have a mean particles size of from about 50 μm to about 500 μm, or from about 50 μm to about 5 mm. Optionally, surfactants, fatty acid esters, and/or other compounds can be added to modify the hydrophobicity of metal rich particles within the ore suspension and improve their association with air bubbles in subsequent steps. Similarly, suppressants can be added to reduce association of undesired particulates (e.g. pyrites) with air bubbles in subsequent steps.

In some embodiments of the inventive concept high purity (e.g. 95%) or greater CaO/Ca(OH)₂ can be added to the conditioner (810) in order to adjust pH to above 10.5 (e.g. pH 11). In other embodiments non-reactive particulates (such as a steel slag or other industrial waste) can be added to the conditioner. In still other embodiments non-reactive particulates can be added to the conditioner along with a low quality lime (e.g. 70% to 90% CaO/Ca(OH)₂ content) and/or high purity CaO/Ca(OH)₂. Alternatively, a source of CaO/Ca(OH)₂ and/or non-reactive particulates can be added to sea water prior to introduction to the conditioner.

The ore suspension is subsequently transferred to a primary foam fractioner (820), where a gas (typically air) is sparged into the suspension in order to generate bubbles. Metal rich particulates in the ore suspension associate with the air bubbles and collect as a foam layer in the upper portion of the primary foam fractioner. This foam can be recovered as the primary concentrate, which is enriched in metals, for example using a pipe, chute, or other conduit that is in fluid communication with an upper portion of the primary foam fractioner. In some embodiments of the inventive concept high purity (e.g. 95%) or greater CaO/Ca(OH)₂ can be added to the primary foam fractioner in order to adjust pH to above 10.5 (e.g. pH 11). In other embodiments non-reactive particulates can be added to the primary foam fractioner along with low-quality lime and/or high purity CaO/(OH)₂. In still other embodiments non-reactive particulates (such as steel slag) can be added to the primary foam fractioner prior to the addition of low-quality lime and/or high purity CaO/Ca(OH)₂.

It should be appreciated that non-reactive particulates can be added to the conditioner (810), and either a high or low quality source of CaO/Ca(OH)₂ added to the primary foam fractioner (820). Alternatively, if a high quality source of CaO/Ca(OH)₂ is used it can be added to the conditioner, the primary foam fractioner, or both without the need to add non-reactive particulates. In still other embodiments a low quality source of CaO/Ca(OH)₂ and non-reactive particulates can be added to the conditioner, the primary foam fractioner, or both. In yet other embodiments, a mixture of high quality and low quality sources of CaO/Ca(OH)₂ can be used in combination with non-reactive particulates in the conditioner, primary foam fractioner, or both. In some embodiments additional quantities of either high or low quality sources of CaO/Ca(OH)₂ can be added to the primary foam fractioner following addition of such a calcium source to the conditioner.

Removal of metal rich particulates from the ore suspension leaves behind an extracted ore that includes relatively metal-poor particulates in the form of tailings. These can be recovered from either the lower portion of the secondary foam fractioner (830), for example through the use of a pipe, tube, or similar conduit. Additional metal can be extracted from this extracted ore by transferring to a secondary foam fractioner (830). In some embodiments additional reagents can be added to the extracted ore in order to facilitate association of partially metal-enriched particulates of the extracted ore with bubbles introduced into the secondary foam fractioner by sparging with gas. These partially-metal enriched particulates collect as foam in the upper portion of the secondary foam fractioner and can be collected as a secondary concentrate. In some embodiments this secondary concentrate can be utilized directly in subsequent metal recovery processes. In other embodiments the secondary concentrate can be transferred to the conditioner.

The remaining particulates can be collected from the secondary foam fractioner (830) as tailings. Such tailings can be utilized for various purposes, including use as non-reactive particles in methods of the inventive concept and fillers (for example, in building materials such as concrete). In some embodiments such tailings can be subsequently processed to recover additional commercially valuable materials, for example by additional rounds flotation using different reagents that facilitate recovery of different metal species by foam floatation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1-50. (canceled)

51. A method of adjusting pH of sea water to pH 10.5 or higher, comprising contacting sea water, in the absence of additional pH adjusting agents, with a plurality of first particulates comprising a basic compound and a plurality of second particulates that are non-reactive with sea water to generate a pH adjusted sea water with pH of 10.5 or higher, wherein the second particulates are present at an at least a 1:1 w/w ratio with the first particulates.

52. The method of claim 51, wherein sea water is contacted with the first and second particulates simultaneously.

53. The method of claim 51, wherein sea water is contacted with the second particulates prior to application of the first particulates.

54. The method of claim 51, wherein the second particulates are present at an at least a 10:1 w/w ratio with the first particulates.

55. The method of claim 51, wherein the basic compound is a Group I metal oxide or hydroxide or a Group II metal oxide or hydroxide.

56. The method of claim 51, wherein the basic compound is a nitrogen-based basic compound or an organic amine.

57. The method of claim 55, wherein the basic compound is lime or a composition comprising CaO, Ca(OH)₂, or a combination thereof at a purity of at least 70%.

58. A flotation circuit for concentrating metal-rich particulates from an ore, comprising:
a conditioner comprising an upper portion and a lower portion, wherein the conditioner is in fluid communication with a source of sea water;
a primary foam fractioner in fluid communication with the lower portion of the conditioner, wherein the primary foam fractioner comprises an upper portion and a lower portion; and
a source of first particulates comprising a base, wherein the source of first particulates is in fluid communication with at least one of the conditioner and the primary foam fractioner.

59. The flotation circuit of claim 58, comprising a source of ore that is in fluid communication with the conditioner.

60. The flotation circuit of claim 59, comprising a re-sizing device interposed between the source of ore and the conditioner.

61. The flotation circuit of claim 58, comprising a source of second particulates that are non-reactive with sea water, wherein the source of second particulates is in fluid communication with at least one of the conditioner and the primary foam fractioner.

62. The flotation circuit of claim 58, wherein the lower portion of the primary foam fractioner is in fluid communication with a secondary foam fractioner, and wherein the secondary foam fractioner comprises an upper portion and a lower portion.

63. The flotation circuit of claim 62, wherein the upper portion of the secondary foam fractioner is in fluid communication with the conditioner.

64. The flotation circuit of claim 58, further comprising a first collection conduit for a primary concentrate derived from the ore, wherein the collection conduit is in fluid communication with the upper portion of the primary foam fractioner.

65. The flotation circuit of claim 58, further comprising a second collection conduit for tailings derived from the ore, wherein the second collection conduit is in fluid communication with the lower portion of the secondary foam fractioner.

66. A method for recovering a metal from an ore, comprising:
contacting an ore with an extraction mixture comprising sea water and a plurality of first particles comprising a basic compound to form an ore suspension, wherein pH of the extraction mixture is at least 10.5;
sparging the ore suspension with a gas to form a plurality of gas bubbles within the ore suspension for a time sufficient to form a first foam;
collecting the first foam, wherein the first foam comprises a primary concentrate enriched in the metal.

67. The method of claim 66, comprising contacting the ore with a plurality of second particles that are non-reactive with sea water.

68. The method of claim 67, wherein the second particulates are present at an at least a 10:1 w/w ratio with the first particulates.

69. The method of claim 66, wherein the basic compound is selected from the group consisting if a Group I metal oxide or hydroxide, a Group II metal oxide or hydroxide, a nitrogen-based basic compound, and an organic amine.

70. The method of claim 16, comprising:
collecting an extracted ore after sparging;
sparging the extracted ore with the gas to generate a secondary concentrate and tailings;
contacting the secondary concentrate with the extraction mixture; and,
processing tailings to extract or enrich an additional metal.
